(19) United States
(12) Patent Application Publication
(10) Pub. No.: US 2022/0009343 A1
(43) Pub. Date: Jan. 13, 2022

(54) MOTOR VEHICLE COMPRESSED GAS TANK

(71) Applicant: FORD GLOBAL TECHNOLOGIES, LLC, Dearborn, MI (US)

(72) Inventors: Guenter Hans GROSCH, Vettweiss (DE); Bert HOBEIN, Aachen (DE); Thomas Werner STEINKOPF, Cologne (DE); Rolf Lorenz LOEFFLER, Rommerskirchen (DE); Julio OROZCO SANTOS COY, Aachen (DE); Stefan KAIMER, Aachen (DE); Florian HUTH, Cologne (DE)

(73) Assignee: FORD GLOBAL TECHNOLOGIES, LLC, Dearborn, MI (US)

(21) Appl. No.: 17/368,240

(22) Filed: Jul. 6, 2021

(30) Foreign Application Priority Data
Jul. 7, 2020 (DE) 102020117913.8

(51) Int. Cl. B60K 15/03; F28D 1/053; F17C 1/16

(52) U.S. Cl. CPC B60K 15/03006; F28D 1/05366; F17C 1/16; F17C 2201/0138; F17C 2270/0168; F17C 2223/0123; F17C 2203/0362

(57) ABSTRACT

A method for producing a compressed gas tank for a motor vehicle includes inserting a bundle of heat-conducting elements through an opening in a housing of the compressed gas tank and exerting a force on the bundle that radially expands the bundle within the housing beyond the size of the opening. The heat-conducting elements may be helically wound about a central axis when inserted through the opening with a torsional force applied to unwind the elements while radially expanding and reducing axial length of the bundle. A compressed gas tank for a motor vehicle includes a plurality of heat-conducting elements including at least one tube within a tank housing that extend axially along the tank and radially within the housing to a size exceeding an opening of the housing. The tube is configured to circulate coolant to cool compressed gas within the tank.

### CROSS-REFERENCE TO RELATED APPLICATIONS

This application claims foreign priority benefits under 35 U.S.C. § 119(a)-(d) to DE 10 2020 117 913.8 filed Jul. 7, 2020, which is hereby incorporated by reference in its entirety.

### TECHNICAL FIELD

This disclosure relates to a motor vehicle compressed gas tank with internal cooling feature and a method for making a compressed gas tank.

### BACKGROUND

Compressed gas tanks or pressure vessels are used in the automotive sector, e.g. to hold natural gas, liquified petroleum, or hydrogen for fuel cells. In this context, the compressed gas tank usually has a cylindrical middle section, adjoined at the ends by curved or dome-like end sections. A compressed gas tank usually has an inner jacket, which is surrounded by an outer jacket consisting of wound continuous fibers (rovings) in a polymer matrix. Fiber reinforcement is often essential for sufficient pressure resistance. Compressed gas tanks which are made exclusively of metal, as well as those which are made of metal and are fiber-reinforced exclusively in the cylindrical middle section, are known. Other compressed gas tanks have an inner jacket of metal and are fiber-reinforced both in the middle section and in the end sections, while yet others have an inner jacket consisting of a polymer, which is fiber-reinforced in the middle section and in the end sections and which has metal end pieces at the ends for a valve or a closure. During refueling, the compressed gas tank heats up strongly, mainly due to the compression of the gas inside the tank (and possibly in a line leading to the tank). In this case, there may be the risk that a maximum design temperature of the tank is exceeded. To prevent this, either refueling must take place more slowly or the gas must be pre-cooled before refueling, which is expensive in terms of energy. In some cases, refueling must be automatically interrupted to keep the temperature below a designated maximum temperature.

U.S. Pat. No. 9,476,650 B2 discloses a heat exchanger for underwater use including a plurality of tube bundles of the same length, each bundle having a plurality of tubes wound helically about a central axis. Each tube bundle is surrounded by a tubular jacket. End pieces, which are connected by a cylindrical outer wall, are arranged along the central axis on both sides at the ends. The end pieces have openings in which the tubes and the tubular jackets are received on both sides.

CN 105910467 A discloses a horizontally arranged heat exchanger having a cylindrical outer jacket in which a tube bundle is arranged. The tubes of the tube bundle are connected on both sides to end chambers, which have inlet and outlet connections for a first fluid. The outer jacket, for its part, has inlet and outlet connections for a second fluid. The inlet connections are each arranged on the upper side and the outlet connections are arranged on the lower side. The tube bundle has a straight central tube, which extends along a central axis, and a plurality of helically designed outer tubes, which are arranged around the central tube.

CN 203550678 U discloses a cooler having a housing in which a plurality of tubes is arranged which communicate with an oil inlet and an oil outlet at opposite ends of the housing. The tubes are surrounded by a cylindrical outer jacket, which has a water inlet and a water outlet. A plurality of groups of tubes arranged concentrically with respect to one another is provided, the tubes of each group being at the same distance from a central axis of the housing. Furthermore, provision is made for the tubes to be helically wound, the twist of mutually adjacent groups of tubes in each case being opposite.

U.S. Pat. No. 9,964,077 B2 shows a heat exchanger which has a housing that surrounds at least two bundles of tubes, which are each connected on both sides to a header. Each of the bundles has a plurality of tubes, which are wound helically around a common axis. Owing to the helix structure, any heat-related expansion of the individual tubes can be better absorbed without resulting in an excessive axial force on the headers.

In view of the prior the art indicated, the efficient configuration of the filling process in the case of a compressed gas tank of a motor vehicle still leaves room for improvements.

### SUMMARY

Embodiments according to the disclosure enable efficient filling of a compressed gas tank of a motor vehicle.

It should be noted that the features and measures listed individually in the following description can be combined with one another in any technically feasible manner and indicate further embodiments that are not explicitly illustrated or described. The description additionally characterizes and specifies the claimed subject matter in conjunction with the figures.

Embodiments include a compressed gas tank and a method for producing a compressed gas tank for a motor vehicle. The motor vehicle may be a passenger car or a heavy goods vehicle, for example. Under certain circumstances, the compressed gas tank may also be referred to as a liquefied gas tank and normally serves to receive a pressurized gas used to drive the motor vehicle, e.g. hydrogen for a fuel cell or natural gas (compressed natural gas, CNG), dimethyl ether (DME) or, alternatively, liquefied petroleum gas (LPG), normally a mixture of butane and propane, for a correspondingly configured internal combustion engine. Owing to the high pressure, the gas may be completely or partially in the liquefied state within the compressed gas tank in the operating state. Nevertheless, the term “gas” is used here by way of simplification since this corresponds to the state of aggregation under normal conditions even in these cases.

According to various embodiments, a housing of the compressed gas tank is provided, which has an axially extending housing opening. Formed within the housing there is an interior space which, in the operating state, serves to accommodate the pressurized gas. In this context, the “axial direction” is defined as the direction in which the housing opening extends and passes through the housing wall of the housing. However, the axial direction can also correspond to a housing axis along which the housing extends and with respect to which it is at least partially symmetrical. There are different possibilities with regard to the further design of the housing. For example, the housing could have a tangentially encircling middle section and two end sections connected to the latter axially at the ends. The end sections can be prefabricated separately from the middle section, the housing thus being composed of at least three parts which, as a rule, are surrounded overall by an outer jacket as described below. With respect to the axial direction, the middle section is designed to be circumferentially encircling, i.e. it surrounds the housing axis in the manner of a cylinder jacket. Normally, the cross section of the middle section is of circular design and is at least approximately constant along the axial direction. Connected to the middle section at the axially opposite ends of the middle section there is in each case an end section, although it is also possible for the said sections to be manufactured in one piece with one another. Alternatively, the end sections can be manufactured separately, in which case it is also possible to speak of end pieces. The shape of the respective end section can have a convex (or possibly also concave) curvature, at least in some section or sections.

In one embodiment, the housing opening is formed in one of the end sections or end pieces and, in particular, can be formed symmetrically with respect to the housing axis. There are no restrictions with regard to the materials of the housing within the scope of the invention. Normally, the end pieces consist of metal, e.g. aluminum. The middle section may consist, for example, of a polymer or likewise of a metal. The housing parts described here can, in particular, form an inner jacket or liner of the housing, which on the outside can be completely or partially wrapped with bundles (so-called rovings) of continuous fibers, e.g. carbon fibers, glass fibers, aramid fibers, etc., or else mixtures of different fibers, which in turn are incorporated into a polymer matrix. In particular, the pressure resistance of the tank can be improved by this fiber reinforcement. As a rule, one of the following types of compressed gas tanks is produced: pure metal containers, metal containers which are reinforced with fiber laminate in the middle section, metal containers which are completely reinforced with fiber laminate, or containers which have a middle section of polymer and end pieces of metal and are completely reinforced with fiber laminate.

A bundle of heat-conducting elements is introduced, with a first end in the lead, at least partially into the housing through the housing opening. In the fully assembled state, the heat-conducting elements serve to dissipate heat from the interior of the housing. This is advantageous particularly when filling the compressed gas tank, during which it could heat up strongly, mainly due to the compression of the gas. However, since at least some of the heat generated by compression can be released to the heat-conducting elements and dissipated via them, the heating of the compressed gas tank is limited, making it easier to comply with a desired maximum temperature limit of the tank. This, in turn, has the advantage that refueling can be carried out more quickly without the need to pre-cool the gas.

The heat-conducting elements may be made of metal, e.g. stainless steel. As an option, they can have a surface coating, although this should be selected in such a way that it does not significantly restrict thermal conductivity. In general, each heat-conducting element may be referred to as elongate, thus having an extent along a direction which may be referred to as the longitudinal direction or the direction of extent, which normally corresponds to at least five times or at least ten times an extent transverse to the direction of extent. The external cross section of a heat-conducting element can be of different designs, e.g. polygonal, rectangular, oval, or circular. The external cross section may be constant along the entire length of the heat-conducting element, but it could also vary. The bundle has a plurality of heat-conducting elements, the number of which can be between 4 and 20 or between 6 and 15, for example. Within the bundle, each heat-conducting element is normally arranged adjacent to at least one other heat-conducting element, typically to at least two other heat-conducting elements. In various embodiments, each heat-conducting element touches at least one other heat-conducting element, at least in some region or regions.

The bundle of heat-conducting elements has a first end and is introduced, with this first end in the lead (or forwardmost), at least partially into the housing through the housing opening. Here, the direction of movement during introduction can correspond at least approximately to the axial direction, it being possible, for example, for it to deviate by less than 20° from the axial direction. As explained below, the bundle may be introduced only partially into the interior, such as 50% to 80% of its undeformed length, while the remaining 50% to 20%, respectively, initially remains outside the housing. The introduction of the bundle can be performed manually but it is preferably performed automatically.

After the at least partial introduction, at least one force is exerted on the second end of the bundle, expanding the bundle radially within the housing and simultaneously contracting or reducing the length along the axial direction. The second end of the bundle is arranged opposite the abovementioned first end, i.e. it is arranged at the rear with respect to the direction of movement of introduction. Typically, it is still arranged outside the housing after the (partial) introduction of the bundle. At least one force is exerted on the second end. The force can be exerted directly or via at least one interposed element. Even if, in principle, the at least one force could be exerted manually, it is preferred for reasons of precision that it be exerted automatically. In particular, it can also be a force couple corresponding to a torque. Strictly speaking, the at least one force is exerted on the second end relative to the first end. That is to say, a counterforce simultaneously acts on the first end, preventing the bundle from simply moving as a whole due to the action of said force. Exerting the at least one force has the effect that the bundle expands radially within the housing. That is to say that, if the expansion of the overall bundle transversely to the axial direction, namely in the radial direction, is considered, this extent is increased by the exertion of the at least one force. It might also be stated that the individual heat-conducting elements of the bundle move away from one another, with the result that the outer circumference of the bundle as a whole radially expands or is spread apart. During this process, the expansion or spreading apart does not normally take place along the entire length of the bundle but only in a certain region or regions. In particular, it is also not necessary for it to take place uniformly in all regions of the bundle. The radial expansion may result in a bundle diameter/circumference that exceeds the diameter/circumference of the tank opening in a certain region or regions of the bundle.

The effectiveness of cooling that can be achieved by means of the heat-conducting elements is improved by the expansion of the bundle to increase surface area of the heat-conducting elements exposed to the compressed gas, as well as the potential for convective and/or conductive cooling. In this context, the heat-conducting elements of the bundle can initially be introduced in a relatively compact form through the housing opening and then spread apart in the manner described, thereby enabling them to cool a larger volume of the interior. In this case, it is possible to assume, as a model by way of simplification, that each heat-conducting element contributes to the cooling of a certain region in the vicinity of the heat-conducting element. In the compact form in which the bundle is introduced, the corresponding regions of the heat-conducting elements can overlap, which may impair cooling. Moreover, it may be that there are initially no gaps or only minimal gaps between the heat-conducting elements, with the result that gas to be cooled can get between the heat-conducting elements only with difficulty or not at all. After expansion and spreading apart, there are normally sufficient gaps, thus ensuring that each heat-conducting element contributes with its entire surface area to heat exchange.

The path of the individual heat-conducting elements within the bundle can differ. For example, the heat-conducting elements could be arranged in a straight line as they are introduced. In various embodiments, a bundle of helically wound heat-conducting elements is introduced. That is to say that the heat-conducting elements within the bundle are wound helically, at least during introduction, that is to say in the manner of a helix or in the manner of a helical curve. When considered in itself, each heat-conducting element extends helically. Considered overall, it can be stated that the heat-conducting elements are wound around one another or wound at least approximately around a common bundle axis. In this arrangement, all the heat-conducting elements of the bundle are wound in the same direction or in the same sense.

In one embodiment, an axial force is exerted on the second end, thereby compressing the bundle in the axial direction and simultaneously expanding it in the radial direction. This is possible independently of the path of the heat-conducting elements, i.e. these could be formed in a straight line, in a helically wound manner or in some other way. In this case, however, the deformation of the individual heat-conducting elements might be difficult to control as a result of exerting unpredictable forces in particular elements. Moreover, an axial force of considerable magnitude may be necessary and this, in turn, must be compensated for by a corresponding counterforce on the first end. Insofar as the first end transmits the force to the housing, for example, the housing may require reinforcement to reduce the risk of damage to the housing. Various embodiments provide a torsional moment exerted on the bundle by means of the at least one force, as a result of which the twist of the bundle is reduced relative to an initial twist factor. It may also be stated that the torsional moment counteracts the original twist of the bundle upon insertion. Of course, at least one force couple is required for a torsional moment. The torsional moment leads to rotation of the second end relative to the first end. Here, the reduction in twist is normally accompanied by shortening of the bundle, i.e. the distance between the first and the second end decreases. In particular, the second end can initially be arranged outside the housing whereas, after spreading apart has ended, it is arranged within the housing, e.g. within the housing opening.

As already explained, the at least one force or torque which acts on the second end must be compensated for by an opposing force or an opposing torque on the first end to prevent twisting or displacement of the entire bundle. In at least one embodiment, the housing has a second housing opening situated opposite the abovementioned housing opening. This allows holding the first end from the outside of the housing through this second housing opening and thus stabilize it while the force is being exerted on the second end. However, this procedure is generally complicated and requires at least some plastic deformation of the bundle so it does not return to the original twist or length when the second end is released. As such, various embodiments secure the first end of the bundle in a torque-transmitting manner to an end region of the housing which is situated axially opposite the housing opening before exerting the torsional moment or axial compression force. The connection is at least torque-transmitting and, in particular, can be secure against rotation of the first end, ensuring that the first end cannot twist relative to the housing. Torque transmission can be achieved by nonpositive engagement, possibly by materially integral engagement and/or, in particular, positive engagement, for example.

The bundle may be non-rotatably connected at the first end to an engagement element, which is positively engaged with the engagement region. The first engagement element can be connected positively, non-positively and/or in a materially integral manner to the heat-conducting elements of the bundle. For example, it can have apertures that pass through or are open towards the second end, in which the ends of the heat-conducting elements are accommodated. On an opposite side, which faces the engagement region, the engagement element has structures which allow positive engagement, in particular positive engagement in a tangential direction. These can be axial projections and/or apertures, for example. These correspond to structures of an engagement region. For example, first engagement elements could have a projection that can be introduced into an aperture in the engagement region or vice versa. By means of the positive engagement, twisting of the first end relative to the engagement region is prevented. It would also be conceivable for the engagement element to have an external thread that is screwed into an internal thread formed in the engagement region.

As already explained above, the bundle can be introduced in a compact form through the housing opening and then expanded radially, thereby making possible more effective, more uniform cooling of the interior of the housing. In particular, a radial extent of the bundle can increase during expansion to exceed the radial extend of the opening, and may increase by at least 100%, possibly also by at least 200%, at least in some region or regions. For example, the bundle could be introduced without problems through an end opening if its outside diameter were less than 5 cm and then spread apart to an outside diameter of 10 cm, 15 cm or more.

The expansion may result in predominantly elastic deformation of the heat-conducting elements. The same applies to the reduction in the twist of the bundle. There is thus no plastic deformation, or at most negligible plastic deformation, of the heat-conducting elements. Such plastic deformation, which would be associated with at least local overshooting of the yield point for example, could have a disadvantageous effect on the durability of the heat-conducting elements. Combined with relatively large temperature differences, this could lead to cracks in the heat-conducting elements. Moreover, there is the risk with plastic deformation that the cross sections of the through channels will be reduced and flow will be hindered. Whether the deformation remains within the elastic range can be checked by means of the specific deformation which occurs and the known material properties of the heat-conducting elements.

The heat-conducting elements can be of solid design, e.g. as metal bars, which dissipate heat from the interior of the compressed gas tank purely on the basis of heat conduction. According to one embodiment, at least one heat-conducting element has a through channel for a coolant. In particular, this can apply to all the heat-conducting elements. The respective heat-conducting element has a through channel which is formed continuously along the entire length of the heat-conducting element. The heat-conducting element may therefore be referred to as hollow or, at least in the broadest sense, tubular or annular. In this case, one may also refer to a heat-conducting tube. The cross section of the through channel can be of different designs, e.g. polygonal, rectangular, oval or, especially, circular. Normally, the cross section is constant along the entire length of the heat-conducting element, but it could also vary to provide desired flow and/or pressure characteristics of the coolant. It would be conceivable for a heat-conducting element to have a plurality of through channels, but normally each heat-conducting element has precisely one through channel, i.e. only one through channel.

In this context, it is envisaged that the respective through channel is connected or has been connected at least indirectly to two coolant connections, which, in particular, can each be arranged on the same end of the end sections, or on opposite ends. As a general rule, the connection is established before the bundle is introduced into the housing. The two coolant connections form an inlet and an outlet for coolant. It is self-evident here that one end of the through channel is connected (directly or indirectly) to one coolant connection, while the other end is connected to the other coolant connection. The coolant connections can be connected to a coolant circuit of the motor vehicle during the installation of the compressed gas tank. In other words, the compressed gas tank is incorporated into the coolant circuit in the installed state, the coolant flowing in through one of the coolant connections (which may also be referred to as the inlet coolant connection) and back out again through the other (which may also be referred to as the outlet coolant connection). In this case, owing to the described connection of the through channel to the coolant connections, the coolant is likewise passed through the through channel. In particular, provision can be made for the through channels to have a group of first through channels and a group of second through channels, the first through channels being arranged upstream of the second through channels. Thus, the first through channels are connected to the outlet coolant connection via the second through channels (and optionally further lines or channels), while the second through channels are connected to the inlet coolant connection via the first through channels (and optionally further lines or channels). As an alternative to a coolant circuit of the motor vehicle, it would also be possible to use an at least partially external coolant circuit, e.g. a coolant circuit of a filling station for the compressed gas tank.

Since the through channel is formed within the heat-conducting element, which, in turn, passes through the interior of the compressed gas tank, heat exchange can take place between the coolant in the through channel and the gas in the interior of the compressed gas tank. In this case, the heat is not transferred only by heat conduction but also by convection, i.e. by the coolant flow in the through channel and gas flow around the heat-conducting elements. This is generally significantly more effective than heat transfer by heat conduction only. The coolant can be a conventional liquid coolant of the motor vehicle, e.g. a water-glycol mixture. This can also be used to cool or control the temperature of other components of the vehicle. The heat which is transferred from the compressed gas to the coolant can be dissipated to the external surroundings of the vehicle at some other point via a radiator or, alternatively, can also be used to heat the vehicle interior.

According to one embodiment, the heat-conducting elements are connected to one another at the second end by a header element, and an external thread of this header element is screwed into an internal thread of the housing opening. That is to say that the housing opening has an internal thread which interacts with an external thread formed on the header element. Like the heat-conducting elements, the header element can be formed from metal and, for example, can have apertures in which the ends of the heat-conducting elements are received with positive engagement. The second end is secured on the housing by screwing the header element into the housing opening. During this process, there is, of course, also rotation of the second end, by means of which the twist of the bundle can simultaneously be reduced and the bundle spread apart. In the embodiment described here, both coolant connections can be arranged on the header element, while at least one deflection channel is formed on the engagement element. Each deflection channel connects at least one first through channel to at least one second through channel and can be of U-shaped design. A first collecting channel, which is connected to the inlet coolant connection, and a second collecting channel, which is connected to the outlet coolant connection, can be formed in the header element. The first collecting channel can be connected to the first through channels via first branch channels, while the second collecting channel is connected to the second through channels via second branch channels. Each of the collecting channels can be of annular design.

The header element, in turn, can have an axial through opening, into which a valve or a closure element is introduced and secured therein. In this case, it is possible, in particular, for the through opening to be centered with respect to the housing axis and for the ends of the heat-conducting elements to be arranged around the through opening (with a radial clearance). Likewise, the through opening is normally arranged concentrically with respect to the abovementioned housing opening. It is possible to introduce and, for example, screw a valve into the through opening, and this valve can then be used for filling the compressed gas tank. That is to say: in this case, the compressed gas tank is filled from the same end as the (first) housing opening. As an alternative, provision can be made to fill the compressed gas tank from the opposite end, in which case a corresponding valve is arranged there. The (first) housing opening can then be closed by means of a closure element (end plug), which can likewise be secured, e.g. by screwing in.

Further advantageous details and effects are explained in greater detail below with reference to representative embodiments illustrated in the figures, of which:

### BRIEF DESCRIPTION OF THE DRAWINGS

FIGS. 1-4 show a sectional illustration of a compressed gas tank during various phases of assembly according to representative embodiment of a method according to the disclosure;

FIGS. 5-7 show a detail view of a bundle of heat-conducting tubes during various phases of expansion during assembly according to embodiments of the disclosure;

FIG. 8 shows a perspective illustration of a cooling bundle with cooling tubes coupled by a header element;

FIG. 9 shows a partial sectional illustration of part of a cooling bundle coupled by a header element from FIG. 8;

FIG. 10 shows a sectional illustration in accordance with the line X-X in FIGS. 9; and

FIG. 11 shows a partial sectional illustration of part of a cooling bundle with an engagement element.

### DETAILED DESCRIPTION

As required, detailed embodiments are disclosed herein; however, it is to be understood that the disclosed embodiments are merely representative and may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the claimed subject matter.

In the various figures, identical parts are in all cases provided with the same reference signs, for which reason they are also generally described only once.

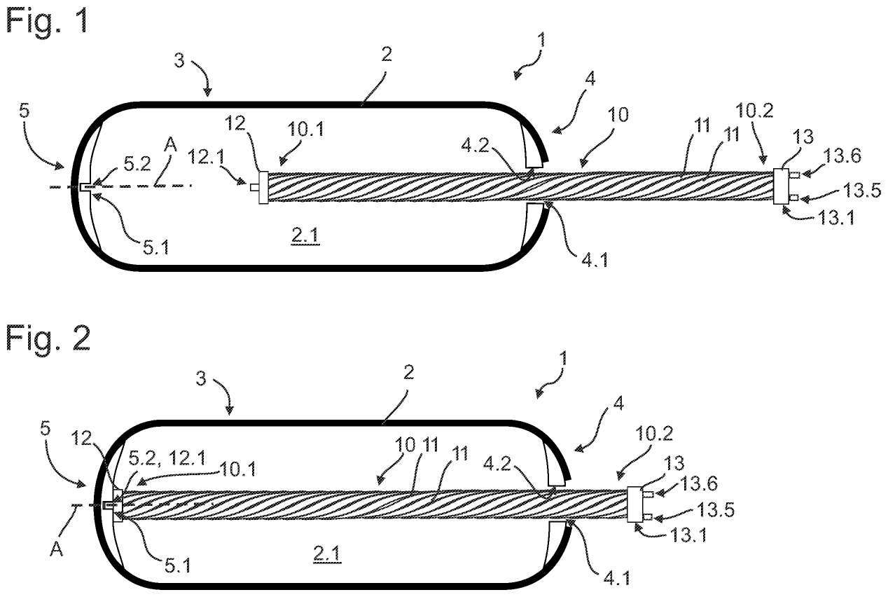

FIG. 1 shows a sectional view of a compressed gas tank 1 for a motor vehicle, which can be used, for example, in a passenger car, during a first phase of assembly according to one or more embodiments. The section plane in FIG. 1 runs parallel to a housing axis A, which corresponds to an axial direction. The housing axis A forms an axis of symmetry of the compressed gas tank 1. The latter has a housing 2, with a middle section 3 in the form of a cylinder jacket, which is adjoined axially at the ends by a first end section 4 and a second end section. The illustration of the housing 2 is greatly simplified here. Normally, this has an inner jacket of plastic and/or metal, which is surrounded by an outer jacket consisting of wound rovings (continuous fibers) in a polymer matrix. An axially extending housing opening 4.1 is formed in the region of the housing axis A in the first end region 4. In the second end region 5, an engagement region 5.1 is formed, the function of which will be explained in the following.

Furthermore, FIG. 1 shows a bundle 10 of coolant tubes 11 wound helically around one another. In the present example, the coolant tubes 11 are made of stainless steel. Each coolant tube 11 has at least one through channel 11.1, 11.2, wherein a group of first through-channels 11.1 and a group of second through channels 11.2, which will be explained below, can be functionally distinguished. At a first end 10.1, the coolant tubes 11 are connected to one another by an engagement element 12, which has an engagement structure 12.1 in the form of a projection. This is of complementary design to an engagement structure 5.1 of a second engagement element 5.2, said structure being formed in the end region 5. The ends of each coolant tube 11 can be accommodated in apertures (not illustrated here) of the respective engagement element 12 and can be screwed in, for example. Thus, the coolant tubes 11 could first of all be screwed into the engagement element 12 and then twisted before being introduced into the compressed gas tank 1, thus enabling the illustrated helical configuration to be achieved. However, it is also conceivable for the coolant tubes 11 winding helically around one another to be held in a manner secure against rotation by the engagement element 12, wherein a nonpositive, materially integral or positive joint is envisaged. For example, the engagement element 12 can be embodied in the manner of a sleeve and can hold the bundle in a manner secure against rotation, engaging around the outside of said bundle, wherein the engagement structure 12.1 is arranged on a closed end of the engagement element 12.

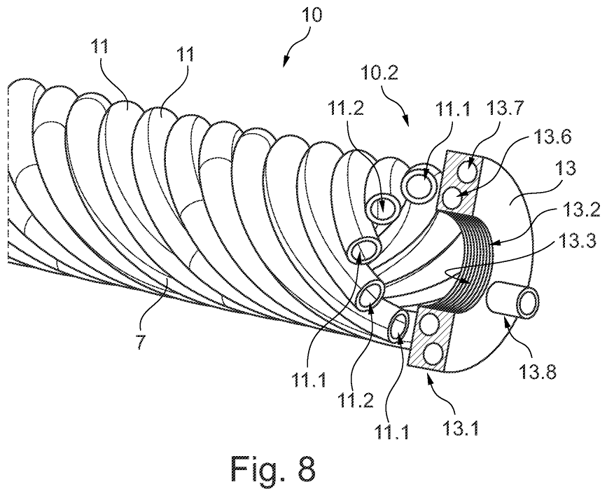

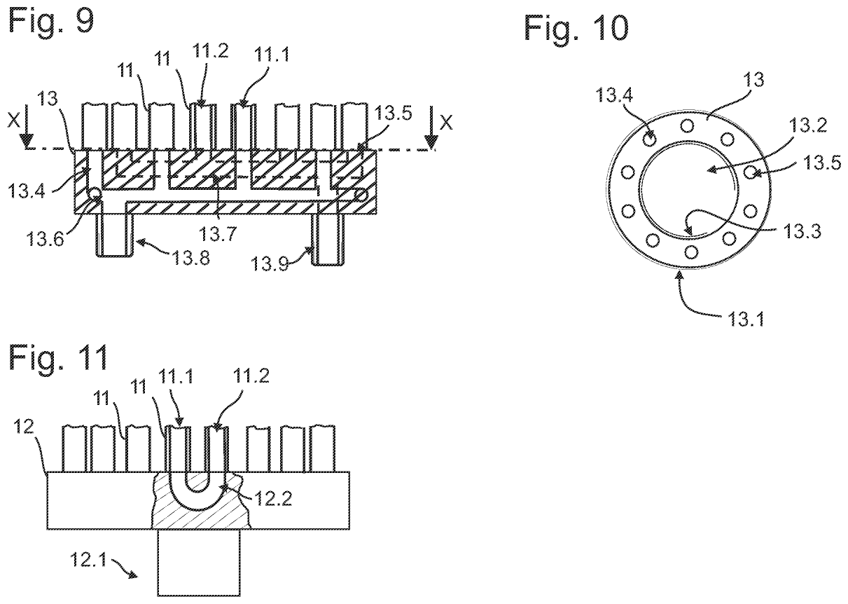

As can be seen in FIG. 11, the engagement element 12 has a plurality of U-shaped deflection channels 12.2, each of which connects a first through channel 11.1 to a second through channel 11.2. At a second end 10.2, the coolant tubes 11 are connected by a header element 13, which is more easily visible in the enlarged illustrations in FIGS. 8-10. Overall, the header element 13 is of annular design and has an external thread 13.1 and, in a through opening 13.2, an internal thread 13.3. A plurality of first branch channels 13.4 is furthermore formed, each of said channels being connected to a first through channel 11.1 of one of the coolant tubes 11, and a plurality of second branch channels 13.5 is also formed, each of said channels being connected to a second through channel 11.2. The first branch channels 13.4 are connected via an annular first collecting channel 13.6 to an inlet coolant connection 13.8, while the second branch channels 13.5 are connected via a likewise annular second collecting channel 13.7 to an outlet coolant connection 13.9. Both coolant connections 13.8, 13.9 are arranged on the header element 13.

In FIG. 1, the bundle 10 is introduced, with the first end 10.1 in the lead, partially into an interior 2.1 of the housing 2 through a housing opening 4.1 in the first end region 4, said opening passing through in the axial direction. Here, the direction of movement during introduction corresponds at least approximately to the axial direction.

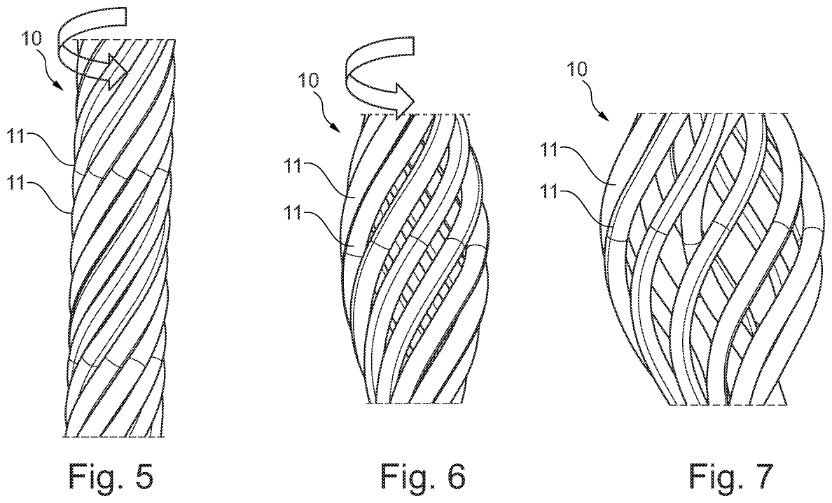

In FIG. 2, the bundle 10 has been introduced to an extent such that the first engagement element 5.2 comes into positive engagement with the second engagement element 12, thereby preventing twisting of the engagement element 12 relative to the housing 2. The length of the bundle 10 is dimensioned in such a way that a part thereof is still outside the housing 2 with the header 13. As the process continues, a torque (corresponding to a force couple) is exerted on the second end 10.2, leading to a torsional moment acting on the bundle 10. This state is also illustrated in FIG. 5, where only a part of the bundle 10 can be seen.

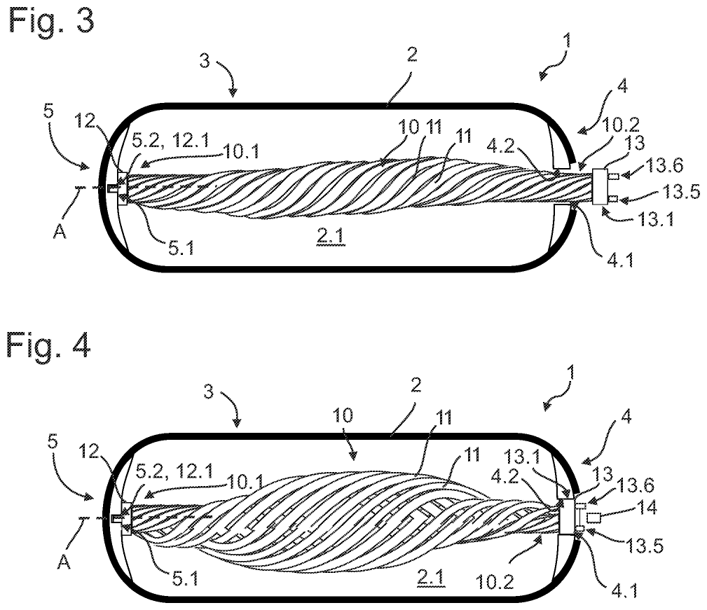

As the process continues, the torque exerted has the effect that the twist of the bundle 10 decreases while, at the same time, its length in the axial direction is reduced. As a result, the radial dimension of the bundle 10 (its outer radius) within the compressed gas tank 1 increases, while the header 13 is moved closer to the housing opening 4.1. This is illustrated in FIG. 3 and in FIG. 6.

The process described is continued until, as illustrated in FIG. 4 and FIG. 7, the bundle 10 has been spread apart to such an extent that the radial dimension thereof has increased by more than 200% relative to the original state. It thus fills the interior 2.1 of the housing 2 significantly better than in the original state shown in FIG. 2. In one embodiment, the largest radial dimension of the bundle (typically in the middle of the bundle) increases beyond the radial dimension of the housing opening 4.1 to about one-half of the radial dimension of the housing 2. Moreover, significant gaps between the individual heat-conducting tubes 11 can be seen. The entire process of spreading the bundle 10 apart is accomplished by primarily elastic deformation of the individual heat-conducting tubes 11. Finally, the external thread 13.1 of the header 13 is screwed into an internal thread 4.2 of the housing opening 4.1. The sense of rotation for screwing in is expediently chosen in such a way that the bundle spreads further apart. In addition, a valve 14 (illustrated in schematic form here) can be screwed into the through opening 13.3. By means of the valve 14, the interior 2.1 of the housing 2 can be filled with a pressurized gas (e.g. hydrogen, natural gas, DME or LPG), which is used to drive the motor vehicle.

In the installed state, the through channels 11.1, 11.2 of the coolant tubes 11 can be connected to a coolant circuit of the motor vehicle, which carries a liquid coolant (e.g. a water-glycol mixture) and is used for temperature control, i.e. cooling and/or heating, of various vehicle components or zones. More precisely, the inlet coolant connection 13.8 is connected to a coolant feed line (not illustrated), while the outlet coolant connection 13.9 is connected to a coolant discharge line. In this way, coolant can flow into the first through channels 11.1 via the inlet coolant connection 13.8, the first collecting channel 13.6 and the first branch channels 13.4. From there, the coolant passes via the deflection channels 12.2 into the second through channels 11.2 and onward via the second branch channels 13.5 and the second collecting channel 13.7 to the outlet coolant connection 13.9. From there, it passes into the coolant discharge line.

During refueling, liquefied gas is introduced from an external tank, via a tank line and valve 14, into the compressed gas tank 1. As it flows into the compressed gas tank 1, the gas flows through the gaps between the coolant tubes 11 and has relatively large-area contact with the coolant tubes 11. During this process, there is heat exchange between the gas, which heats up as it is introduced, and the cooling fluid in the through channels 11.1, 11.2. The heating of the gas is reduced by the heat exchange with the cooling fluid that is provided via the wall of the respective coolant tube 11. It is thereby possible to prevent the temperature of the gas and of the compressed gas tank 1 from exceeding a specified threshold, even when refueling takes place relatively quickly. External pre-cooling of the gas is not necessary for this purpose. The heat absorbed by the cooling fluid is dissipated via the coolant circuit and can be released via a heat exchanger, for example, to a vehicle interior or, alternatively, to the surroundings of the vehicle. As an alternative to a cooling circuit of the motor vehicle, a connection to a (partially) external cooling circuit associated with the filling station at which the compressed gas tank 1 is being refilled would also be possible

While representative embodiments are described above, it is not intended that these embodiments describe all possible forms of the claimed subject matter. Additionally, the features of various implementing embodiments may be combined to form further embodiments that may not be explicitly illustrated or described. While various embodiments may have been described as providing advantages or being preferred over other embodiments or prior art implementations with respect to one or more desired characteristics, as one of ordinary skill in the art is aware, one or more features or characteristics may be compromised to achieve desired overall system attributes, which depend on the specific application and implementation. These attributes include, but are not limited to: cost, strength, durability, life cycle cost, marketability, appearance, packaging, size, serviceability, weight, manufacturability, ease of assembly, etc. Embodiments described as less desirable than other embodiments or prior art implementations with respect to one or more characteristics are not necessarily outside the scope of the disclosure and may be desirable for particular applications.

What is claimed is:

1. A method of producing a compressed gas tank for a vehicle, comprising:
inserting a bundle of heat-conducting elements through an opening in one end of a housing of the compressed gas tank;
applying a force to the bundle that radially expands at least a portion of the bundle within the housing to a radius that exceeds a radius of the opening; and
securing the bundle within the housing.

2. The method of claim 1 wherein the heat-conducting elements are helically wound around a central axis.

3. The method of claim 2 wherein applying a force comprises applying a torsional force to at least partially unwind the helically wound heat-conducting elements.

4. The method of claim 3 wherein the housing includes an engagement region positioned opposite the opening and wherein inserting the bundle comprises non-rotatably coupling a distal end of the bundle to the engagement region to oppose the torsional force.

5. The method of claim 4 wherein the heat-conducting elements comprise a plurality of tubes fluidly coupled by an annular header element.

6. The method of claim 1 wherein the bundle has an axial length that exceeds an axial length of the housing and wherein applying a force to the bundle reduces the axial length of the bundle to fit within the housing.

7. The method of claim 1 wherein the heat-conducting elements comprise at least one tube configured to circulate a coolant.

8. The method of claim 7 wherein the heat-conducting elements comprise a plurality of tubes fluidly coupled by an annular header.

9. The method of claim 8 wherein the annular header comprises a compressed gas valve secured within a central portion thereof.

10. The method of claim 8 wherein the annular header comprises a threaded exterior that cooperates with a threaded interior of the opening in the housing.

11. The method of claim 10 wherein the annular header comprises a threaded interior annulus that cooperates with a threaded exterior of the compressed gas valve.

12. A compressed gas tank for a vehicle, comprising:
a housing having an opening with a first radius;
a bundle having a plurality of heat-conducting tubes helically wound about a central axis, the bundle having a second radius greater along a central portion of the bundle that exceeds the first radius;
an annular header fluidly coupling a coolant inlet to a first end of at least one of the heat-conducting tubes and a coolant outlet to a second end of at least one of the heat conducting tubes.

13. The compressed gas tank of claim 12 wherein the annular header comprises a threaded exterior cooperating with a threaded interior of the opening in the housing.

14. The compressed gas tank of claim 12 further comprising a compressed gas valve disposed along the central axis of the bundle within the opening of the housing.

15. The compressed gas tank of claim 14 wherein the annular header comprises a threaded exterior cooperating with a threaded interior of the opening in the housing and a threaded interior cooperating with a threaded exterior of the compressed gas valve.

16. The compressed gas tank of claim 12 wherein the housing comprises an engagement structure opposite the opening configured to secure a distal end of the bundle from rotation during assembly of the compressed gas tank.

17. A system comprising:
a plurality of heat-conducting tubes helically wound about a central axis;
a coupler mechanically securing a first end of the heat-conducting tubes, the first coupler including an engagement structure configured to engage a housing of a compressed gas tank and prevent rotation of the coupler relative to the housing; and
an annular header fluidly coupled to a second end of the heat-conducting tubes, the annular header having a coolant inlet and a coolant outlet each connected to associated heat-conducting tubes.

18. The system of claim 17 further comprising a compressed gas tank housing having an opening at one end configured to secure the annular header, and a second engagement structure configured to engage the engagement structure of the coupler.

19. The system of claim 18 wherein the annular header comprises exterior threads configured to engage interior threads of the opening.

20. The system of claim 19 further comprising a compressed gas valve positioned along a central axis of the housing and secured within an interior of the annular header.
